(19) United States
(12) Patent Application Publication
(10) Pub. No.: US 2009/0251318 A1
(43) Pub. Date: Oct. 8, 2009

(54) Anti-theft system of mobile device

(75) Inventor: Bamboo HO, Shanghai City (CN)

Correspondence Address: BACON & THOMAS, PLLC, 625 SLATERS LANE, FOURTH FLOOR, ALEXANDRIA, VA, 22314-1176, US

(73) Assignee: Inventec Appliances Corp., Taipei (TW)

(21) Appl. No.: 12/318,288

(22) Filed: Dec. 24, 2008

(30) Foreign Application Priority Data
Apr. 2, 2008 (TW) 097111959

(51) Int. Cl. G08B 13/14

(52) U.S. Cl. 340/571; 340/572.1

(57) ABSTRACT

The present discloses an anti-theft system including a mobile device and a radio frequency identification tag. The mobile device includes a processor, a RFID module and an alarm module, and the processor is coupled separately to the RFID module and the alarm module. The RFID module periodically transmits a detection signal to the RFID tag. After the RFID tag receives the detection signal, the RFID tag transmits an acknowledge signal to the RFID module. When the RFID tag leaves a predetermined range from the mobile device, the mobile device will be unable to receive the acknowledge signal, and then perform an emergency processing procedure.

### FIELD OF THE INVENTION

The present invention relates to an anti-theft system of a mobile device, and more particularly to an anti-theft system comprising a mobile device and a radio frequency identification (RFID) tag.

### BACKGROUND OF THE INVENTION

Mobile phone has become a necessary communication tool indispensible to our life. Traditionally, users generally set a password in their mobile phone to prevent the mobile phone from being stolen. When the mobile phone is turned on, a prompting message appears on a display screen of the mobile phone and the user is requested to input a correct password. When the user has made errors of inputting the correct password for a specific number of times, then the mobile phone will be locked automatically to stop receiving further instructions inputted by the user. When the user wants to recover the mobile phone, the user has to contact the communication service provider and go through an identity verification before releasing the locked status of the mobile phone. However, when the mobile phone is stolen or missing during the mobile phone is turned on, then the aforementioned password mechanism cannot prevent any unauthorized use of the mobile phone effectively. Furthermore, information including directories, messages and photos stored in the mobile phone may be used maliciously by a thief. Even if the user encrypts the information of the mobile device, the thief may be able to crack the password of the mobile phone and sell the stolen phone. Therefore, the prior art is not good enough, not only resulting in a possible loss of personal property, but also imposing a risk of jeopardizing the user's privacy and the information security.

In addition, users can use an anti-theft software to achieve the anti-theft function of the mobile phone. When the anti-theft software installed in the mobile phone detects that a subscriber identity module (SIM) card of the mobile phone is replaced, the software will stop the operation of the mobile phone. Users can also use the software to set a keyword in the mobile phone, such that when the mobile phone receives a short message matched with the keyword, the mobile phone will stop receiving the input of an instruction. However, if users have not sent the short message matched with the keyword to the mobile phone when the mobile device is stolen, then it is still difficult to prevent the mobile phone and the SIM card from unauthorized use, and the thief can use the mobile phone maliciously and impose an act that may seriously jeopardize a person's life.

To overcome the foregoing shortcomings effectively, a British company has developed a security technology “Remote XT”, such that when a mobile phone adopting such technology is stolen, a user simply needs to contact the communication company to stop the functions of the mobile phone, delete all personal information (including directories, short messages and photos, etc) stored in the mobile phone, and drive the mobile phone to issue high-decibel sirens continuously, so that the thief finds nowhere to hide. Even if the thief removes the battery of the mobile phone to stop the siren, the mobile device will issue the high-decibel sirens again to disturb the thief whenever the battery is reinstalled into the mobile phone. Since the information stored in the mobile phone has been deleted, the thief cannot access the information, so as to effectively prevent intrusions of the user's privacy, avoid the user's information from being used maliciously by the thief, and further reduce the loss rate of mobile phones. However, when the user's mobile phone is stolen and not discovered in time to notice the communication company in order to lock the mobile phone and delete the information, then the aforementioned method still cannot prevent the mobile phone from unauthorized use or avoid a person's privacy from being intruded.

Therefore, it is an important subject to find a way of overcoming the foregoing shortcomings thoroughly, such that when the distance between the mobile device and the user exceeds a specific range, the mobile phone will perform an emergency processing procedure to prevent the mobile device from being stolen or missing.

### SUMMARY OF THE INVENTION

In view of the foregoing shortcomings of the prior art, the inventor of the present invention based on years of experience in the related industry to conduct extensive researches and experiments, and finally designed an anti-theft system of a mobile phone in accordance with the present invention, in hope of effectively preventing the mobile device from being stolen or missing and unauthorized uses of the mobile device, and protecting a person's privacy from being intruded.

Therefore, it is one aspect of the present invention to provide an anti-theft system of a mobile device, the anti-theft system comprises a mobile device (such as a mobile phone or a PDA) and a radio frequency identification (RFID) tag, wherein the mobile device comprises a processor, a RFID module and an alarm module, and the processor is coupled to the RFID module and the alarm module. The processor transmits a detection signal to the RFID tag within a predetermined range for a predetermined time period through the RFID module. When the RFID tag receives the detection signal, the RFID tag transmits an acknowledge signal to the RFID module. When the RFID tag leaves a predetermined range, resulting in the RFID tag cannot received the detection signal. When the processor cannot receive the acknowledge signal by the RFID module, the processor will issue an alarm (such as a high-decibel siren) through the alarm module to remind the user. Therefore, the RFID tag can be designed and placed in a portable object (such as a keychain, a purse, a necklace or a watch, etc), and the user simply carries the RFID tag, such that when the distance between the mobile device and the RFID tag is too far and exceeds the predetermined range, the mobile device will warn the user, so that the user can locate the mobile device and get back the mobile device quickly to prevent the mobile device from being stolen by others.

Another aspect of the present invention is to provide the mobile device of the anti-theft system further comprising an input interface, wherein the input interface is coupled to the processor, and the processor can receive an instruction inputted by the user through the input interface. When the RFID tag leaves the predetermined range, such that the detection signal cannot reach the RFID tag, and the processor cannot receive the acknowledge signal through the RFID module, the processor will stop receiving the instruction from the input interface. Therefore, others cannot operate the mobile device through the input interface. According to anti-theft system of one embodiment of the present invention prevents unauthorized uses of the mobile device to protect the user's information effectively.

The anti-theft system may further comprising a storage unit, wherein the storage unit is coupled to the processor, and the storage unit is provided for storing a user's personal information. The processor transmits a detection signal to the RFID tag within a predetermined range for a predetermined time period through the RFID module. After the RFID tag receives he detection signal, the RFID tag will transmit an acknowledge signal to the RFID module, such that the processor receives the acknowledge signal through the RFID module. When the processor transmits the detection signals continuously but has not received an acknowledge signal for a number of times equal to a predetermined number of times, the processor will delete the personal information. For example, the user carries the RFID tag, and when the distance between the mobile device and the RFID tag exceeds the predetermined range, and such condition continues for a time equal to a predetermined time, the personal information stored in the storage unit will be deleted. Therefore, the present invention not only prevents the personal information from being used maliciously by others, but also protects a user's personal privacy effectively.

The aspects, technical characteristics and effects of the present invention will become apparent from the following detailed description taken with the accompanying drawings.

### BRIEF DESCRIPTION OF THE DRAWINGS

FIG. 1 is a schematic block diagram of one embodiment of the invention;

FIG. 2 is a flow chart of a first preferred embodiment of the invention;

FIG. 3 is a flow chart of a second preferred embodiment of the invention; and

FIG. 4 is a flow chart of a third preferred embodiment of the invention.

### DETAILED DESCRIPTION OF THE PREFERRED EMBODIMENTS

To make it easier for our examiner to understand the technical characteristics of the present invention, we use preferred embodiments together with the accompanying drawings for the detailed description of the invention as follows:

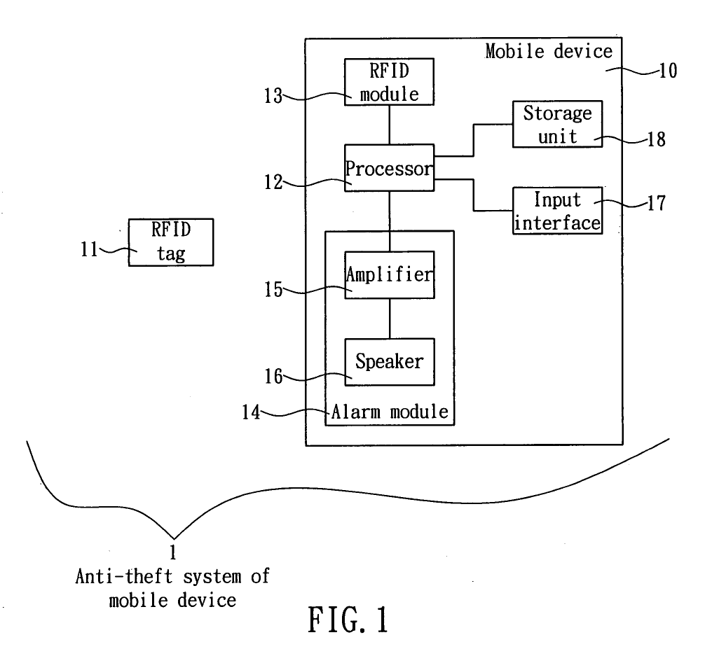

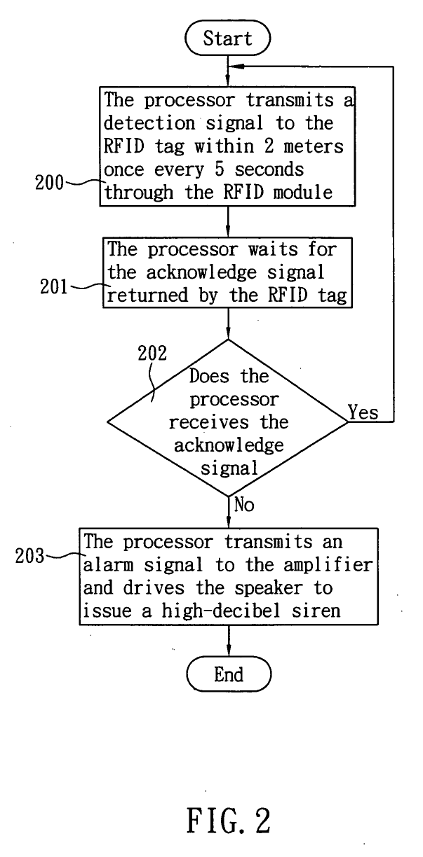

With reference to FIG. 1 for an anti-theft system of a mobile device in accordance with one embodiment of the present invention, a first preferred embodiment of the anti-theft system 1 comprises a mobile device 10 (such as a mobile phone or a PDA) and a radio frequency identification (RFID) tag 11, wherein the mobile device 10 includes a processor 12, a RFID module 13 and an alarm module 14, and the alarm module 14 includes an amplifier 15 and a speaker 16, and the processor 12 is coupled to the RFID module 13 and the amplifier 15, and the speaker 16 is coupled to the amplifier 15. As shown in FIG. 2, the processor 12 turns on the alarm module 14 to remind a user by the following steps:

Step (200): The processor 12 transmits a detection signal to the RFID tag 11 within a predetermined range (such as 2 meters) through the RFID module 13 once every first predetermined time period (such as 5 seconds), and the RFID tag 11 transmits an acknowledge signal to the RFID module 13 after the RFID tag 11 has received the detection signal, so that the processor 12 can receive the acknowledge signal through the RFID module 13.

Step (201): The processor 12 waits for the acknowledge signal returned by the RFID tag 11, wherein the wait time is smaller than the first predetermined time period (such as 2 seconds).

Step (202): The processor 12 determines whether or not the acknowledge signal is received; if yes, then go to Step (200), or else go to Step (203).

Step (203): The processor 12 transmits an alarm signal to the amplifier 15 and drives the speaker 16 to issue a high-decibel siren.

With reference to FIG. 1 for the present invention, a user puts the RFID tag 11 into a purse, and carries the purse in a first preferred embodiment of the invention. When the mobile device 10 is at a distance too far away from the user, and the RFID tag 11 leaves the mobile device 10 for the predetermined range, the detection signal cannot reach the RFID tag 11, and the processor 12 cannot receive the acknowledge signal through the RFID module 13, and thus the processor 12 transmits an alarm signal to the amplifier 15, and the amplifier 15 amplifies the alarm signal, and the speaker 16 produces a high-decibel siren (to perform an emergency processing procedure) to remind the user or disturb the thief, and the user can locate the mobile device 10 and get back the mobile device 10. Such arrangement not only prevents unauthorized use of the mobile device 10 effectively, but also enhances the convenience of the anti-theft application.

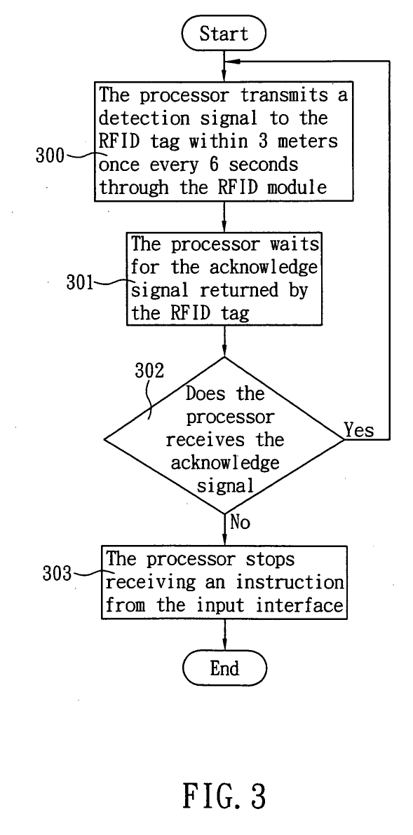

With reference to FIG. 1 for the present invention, a second preferred embodiment of the mobile device 10 comprises an input interface 17 (such as a keyboard or a touch screen) coupled to the processor 12, such that the processor 12 can receive an instruction inputted by a user through the input interface 17. The processor 12 stop receiving the instruction from the input interface 17 according to the following steps as shown in FIG. 3:

Step (300): The processor 12 transmits a detection signal to the RFID tag 11 within a predetermined range (such as 3 meters) once every second predetermined time period (such as 6 seconds) through the RFID module 13, and the RFID tag 11 transmits an acknowledge signal to the RFID module 13 after the RFID tag 11 has received the detection signal, so that the processor 12 can receive the acknowledge signal through the RFID module 13.

Step (301): The processor 12 waits for the acknowledge signal returned by the RFID tag 11, wherein the wait time is smaller than the second predetermined time period (such as 4 seconds).

Step (302): The processor 12 determines whether or not the acknowledge signal is received; if yes, then go to Step (300), or else go to Step (303).

Step (303): The processor 12 stops receiving the instruction from the input interface 17 (an emergency processing procedure).

With reference to FIG. 1, for example, the RFID tag 11 is designed in a keychain, and a user carries the keychain in a second preferred embodiment. When the distance between the RFID tag 11 and the mobile device 10 is greater than the predetermined range, the processor 12 cannot receive the acknowledge signal through the RFID module 13, and thus the processor 12 will stop receiving the instruction from the input interface 17, and others cannot operate the mobile device through the input interface 17. With the anti-theft system of this preferred embodiment, the thief cannot use the stolen mobile device 10 since the input interface 17 is locked. In addition, the thief cannot control the mobile device 10 through the input interface 17 to steal personal information (for example directory, short messages and photos, etc) stored in the mobile device 10. Therefore, the anti-theft system 1 not only provides a simple and convenient use, but also protects the user's privacy effectively.

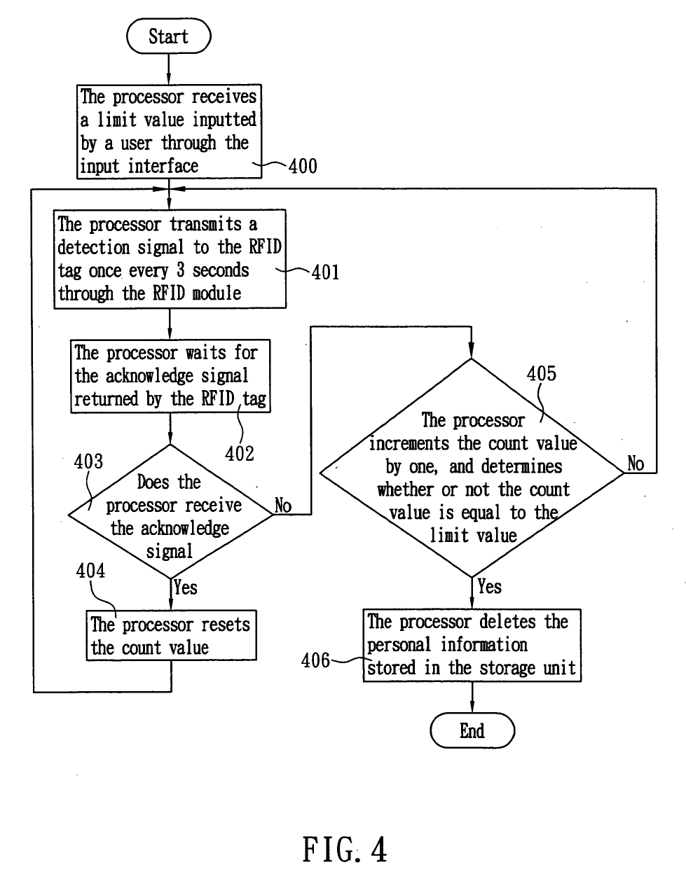

With reference to FIG. 1, a third preferred embodiment of the mobile device 10 further comprises a storage unit 18 for storing a user's personal information (for example, directory, short messages and photos, etc), and the storage unit 18 is coupled to the processor 12, and the processor 12 temporarily stores a count value whose initial value is zero. The processor 12 deletes the personal information stored in the storage unit 18 according to the following steps as shown in FIG. 4:

Step (400): The processor 12 receives a limit value inputted by a user through the input interface 17.

Step (401): The processor 12 transmits a detection signal to the RFID tag 11 within a predetermined range once every predetermined time period (such as 3 seconds) through the RFID module 13, and the RFID tag 11 transmits an acknowledge signal to the RFID module 13 after the RFID module 13 has received the detection signal.

Step (402): The processor 12 waits for the acknowledge signal returned by the RFID tag 11, wherein the wait time is smaller than the predetermined time period (such as 1 second).

Step (403): The processor 12 determines whether or not the acknowledge signal is received; if yes, then go to Step (404), or else go to Step (405).

Step (404): The processor 12 resets the count value, and returns to Step (401).

Step (405): The processor 12 increments the count value by one, and determines whether or not the count value is equal to the limit value; if the two values are equal, then go to Step (406), or else go to Step (401).

Step (406): The processor 12 deletes the personal information stored in the storage unit 18.

In the third preferred embodiment, the user can carry the RFID tag 11, and set a limit value for the mobile device 10 through the input interface 17. When the distance of the mobile device 10 from the user is greater than the predetermined range, the count value will be increased. When the leaving time reaches a third predetermined time, the count value will be accumulated, such that the count value and the limit value will be equal, and the processor 12 will delete the personal information stored in the storage unit 18. Hence, when the user is absent-minded and loses the mobile device 10 several times within a short period, and the missing time is smaller than the third predetermined time, the personal information will not be deleted by mistake, so as to greatly enhance the security of the anti-theft system. In summation of the description above, the anti-theft system 1 not only prevents personal information from being used by others maliciously used, but also protects the user's privacy and overcomes the shortcomings of the prior art effectively.

In the description above, preferred embodiments are used for illustrating the aspects of the present invention, wherein the first predetermined time, the second predetermined time and the third predetermined time can be set to be the same or different. For example, when the third predetermined time is greater than the second predetermined time, and the second predetermined time is greater than the first predetermined time, and a user has lost the mobile device 10, the mobile device 10 will issue the siren and then lock the input interface 17, and finally the processor 12 deletes the personal information stored in the storage unit 18.

The present invention has been described with preferred embodiments thereof and it is understood that many changes and modifications to the described embodiment can be carried out without departing from the scope and the spirit of the invention that is intended to be limited only by the appended claims.

What is claimed is:

1. An anti-theft system, having a mobile device and a radio frequency identification (RFID) tag, and the mobile device comprising:
a RFID module;
a processor, coupled to the RFID module, capable of transmitting a detection signal within a predetermined range through the RFID module by using a first predetermined time as a cycle; and
an alarm module, coupled to the processor; and
the RFID tag, capable of transmitting an acknowledge signal to the RFID module after receiving the detection signal;
such that when the RFID module has not received the acknowledge signal within the period of the first predetermined time after the processor transmits the detection signal through the RFID module, the processor will perform an emergency processing procedure.

2. The anti-theft system of claim 1, wherein the mobile device further comprises an input interface coupled to the processor, so that the processor can receive an instruction inputted by a user through the input interface, and when the RFID module has not received the acknowledge signal within a period of a second predetermined time after the processor transmits the detection signal through the RFID module, the emergency processing procedure performed by the processor is to stop receiving the instruction from the input interface.

3. The anti-theft system of claim 1, wherein the mobile device further comprises a storage unit coupled to the processor for storing a user's personal information, and when the mobile device leaves the RFID tag to a distance exceeding the predetermined range, the leaving time exceeds a third predetermined time, then the emergency processing procedure processed by the processor deletes the personal information stored in the storage unit.

4. The anti-theft system of claim 1, wherein the emergency processing procedure transmits an alarm signal to the alarm module for producing a siren.

5. The anti-theft system of claim 4, wherein the alarm module comprises an amplifier and a speaker, and the amplifier is coupled to the processor and the speaker for amplifying the alarm signal transmitted from the processor and producing the siren through the speaker.
